(19) United States
(12) Patent Application Publication
(10) Pub. No.: US 2019/0057614 A1
(43) Pub. Date: Feb. 21, 2019

(54) A METHOD AND SYSTEM FOR CONTROLLING A TEST ENVIRONMENT ON A MOBILE DEVICE

(71) Applicant: GRAD DNA LTD, Sevenoaks, Kent (GB)

(72) Inventor: Stephen REILLY, Sevenoaks, Kent (GB)

(21) Appl. No.: 16/076,841

(22) PCT Filed: Feb. 10, 2017
(86) PCT No.: PCT/GB2017/050346

§ 371 Date: Aug. 9, 2018

(30) Foreign Application Priority Data
Feb. 10, 2016 (GB) 1602367.3

(51) Int. Cl. G09B 5/12; H04B 1/3827

(52) U.S. Cl. CPC G09B 5/125; H04B 1/3827

(57) ABSTRACT

The present invention relates to a method for controlling a test environment on a mobile device. The method includes modifying device functionality to a locked state prior to a testing phase; providing a test to the user within the testing phase; and modifying device functionality to an unlocked state at the conclusion of the testing phase. A system for controlling a test environment is also disclosed.

### FIELD OF INVENTION

The present invention is in the field of device control. More particularly, but not exclusively, the present invention relates to controlling a test environment on a mobile device.

### BACKGROUND

Scenarios arise where the environment of a device must be controlled to ensure that a user can provide input without interference. One of these scenarios is when a user is providing input for testing or assessment purposes, such that the user is being themselves assessed by a program executing on the device.

A particularly important field where environmental control is necessary is in psychometric testing where results can be ineffective or skewed if the test environment is not strictly controlled. Accordingly, when completing psychometric testing it is important that each user completes the testing in a fare and consistent manner. Traditionally, psychometric tests were pen and paper tests strictly controlled by a test administrator in a classroom environment. Later, test providers published their tests via desktop computers. Test instructions were presented to the user before the user began the test, encouraging them to focus on the tests they were completing, and be undisturbed (e.g. don't take phone calls and tell others not to interrupt them).

It can be seen that, when the environments for the tests are controlled by users, less effective and skewed results are more likely. This would become a particular problem if the tests were deployed on to mobile devices, such as smart-phones or tablets, which are multi-functional and, typically, continually connected to other devices or servers via multiple channel outlets.

There is a desire, therefore, to improve the deployment of tests on mobile devices.

It is an object of the present invention to provide a method and system for controlling test environments on mobile devices which overcomes the disadvantages of the prior art, or at least provides a useful alternative.

### SUMMARY OF INVENTION

According to a first aspect of the invention there is provided a method for controlling a test environment on a mobile device including:
Modifying device functionality to a locked state prior to a testing phase;
Providing a test to the user within the testing phase; and
Modifying device functionality to an unlocked state at the conclusion of the testing phase.

The device functionality may include functions based on communication capability of the device and/or access control. Communication capability may include capabilities such as phone-calls, text messages, and wifi.

The test environment may be under control of a software application executing on the device.

At least some of the device functionality is modified by the software application. The method may further include the step of receiving confirmation at the software application from the user of the device before the software application modifies the device functionality. Confirmation may be received for each of the functions modified by the software application.

The step of modifying device functionality may include:
providing instructions to the user to modify at least some of the device functionality; and
receiving inputs from the user in accordance with the instructions at the operating system of the device to modify at least some of the device functionality.

A software application executing on the device may confirm when the device functionality has been modified by the user. The software application may record this confirmation with the test.

The test may be a psychometric test.

The method may further include the steps of recording the state of the device functionality and associating the recorded state with the test.

According to a further aspect of the invention there is provided a system for controlling a test environment on a mobile device, including:
A processor configured to modify device functionality to a locked state prior to a testing phase, to provide a test to the user within the testing phase and to modify device functionality to an unlocked state at the conclusion of the testing phase; and
A memory configured to store the test.

Other aspects of the invention are described within the claims.

### BRIEF DESCRIPTION OF THE DRAWINGS

Embodiments of the invention will now be described, by way of example only, with reference to the accompanying drawings in which:

FIG. 1: shows a block diagram illustrating a system in accordance with an embodiment of the invention;

FIG. 2: shows a block diagram illustrating a device software architecture in accordance with an embodiment of the invention;

FIG. 3: shows a flow diagram illustrating a method in accordance with an embodiment of the invention;

FIGS. 4a to 4e:
show exemplary screenshots illustrating a software application executing in accordance with a method of an embodiment of the invention; and

FIGS. 5a to 5b:
show diagrams illustrating user interaction with screens generated by a software application executing in accordance with a method of an embodiment of the invention.

### DETAILED DESCRIPTION OF PREFERRED EMBODIMENTS

The present invention provides a method and system for controlling test environments on mobile devices.

Mobiles devices, such as smart-phones, tablets, smart-watches, etc., are susceptible to constant and continual interruptions from the external world (e.g. email, text, Whatsapp™, Twitter™, Facebook™, Linkedin™, etc) and even, perhaps, notifications originating from applications executing on the mobile device itself.

The inventor has discovered that, because most of the interruptions which would disrupt a test occur at the mobile device, the mobile device itself can be used to control the test environment.

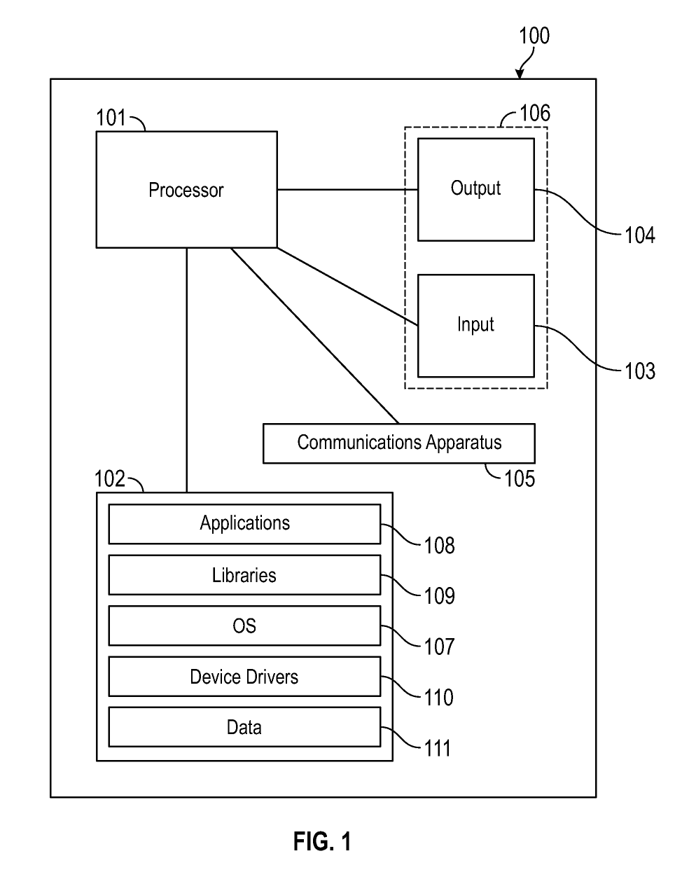

In FIG. 1, a system 100 in accordance with an embodiment of the invention is shown.

The system 100 includes a processor 101, a memory 102, an input apparatus 103, and an output apparatus 104. The system may also include a communications apparatus 105.

The input apparatus 103 may include one or more of a touch/near-touch input, an audio input, a keyboard, a pointer device (such as a mouse), or any other type of input. The touch input may include 3D touch.

The output apparatus 104 may include one or more of a digital screen (such as an LED or OLED screen), an e-ink screen, an audio output, haptic output, or any other type of output.

The input and output apparatuses 103 and 104 may form an integrated user interface 106 such as a touch or near-touch screen.

The system 100, or at least parts of the system, constitute a mobile device 100, such as a smart-phone, a tablet, or a smartwatch. The mobile device 100 may include a common operating system 107 such as Apple iOS, Google Android, or Microsoft Windows Phone.

The system 100 may be configured to provide multi-functionality such as execution of one or more software applications 108, transmitting and receiving communications (e.g. voice communications, text messages, notifications, or any other network communications), and/or monitoring communications or applications and generating notifications. The multi-functionality may be coordinated by the operating system 107 executing on the device 100.

The processor 101 may be configured to provide a test to the user within a testing phase. The test may be a series of questions generated as one or more outputs via the output apparatus 104 (e.g. the test may be displayed as a series of screens via a display screen or generated as audio questions via an audio output). Provision of the test may include receiving one or more answers from the user to each of the questions via the input apparatus 103 (e.g. receiving selection of displayed options via a touch-screen, receiving specific input via a keyboard, or receiving specific input via an audio input).

In one embodiment, the processor 101 provides the test by execution of a testing application.

The processor 101 may be further configured to, prior to providing the test, modify mobile device 100 functionality to a locked state.

The processor 101 may be further configured to, after providing the test, modify the mobile device 100 functionality to an unlocked state.

Mobile device 100 functionality may include communications capability of the device 100 and/or access control. Access control may include control of access to software applications 108, software application 108 functionality, or operating system 107 functionality. Operating system 107 functionality may include notifications generated by software applications 108 on the device 100. Communications capability may include phone-calls, text messages, and/or network access. Network access may include Internet access, LAN/WLAN access, and device-to-device access. It will be appreciated that other communications capabilities and access controls can be envisaged.

Modification of device 100 functionality to a locked state may include blocking or otherwise restricting any of the above communications capabilities or preventing or otherwise restricting access.

The memory 102 may be configured to store the software applications 108, libraries 109, the operating system 107, device drivers 110, and data 111. The data 111 may include the test and answers provided by a user to the test. The software applications 108 may include the testing application and one or more third party applications.

The processor 101 is configured to execute the software applications 108, libraries 109, operating system 107, and device drivers 110, and to retrieve data 111.

The communications apparatus 105 may be configured to communicate with one or more other devices or servers via a communications interface such as wifi, Bluetooth, and/or cellular (e.g. 2G, 3G, or 4G) and/or across a network (such as a cellular network, a private LAN/WLAN and/or the Internet). The servers may include third party servers such as a notification server.

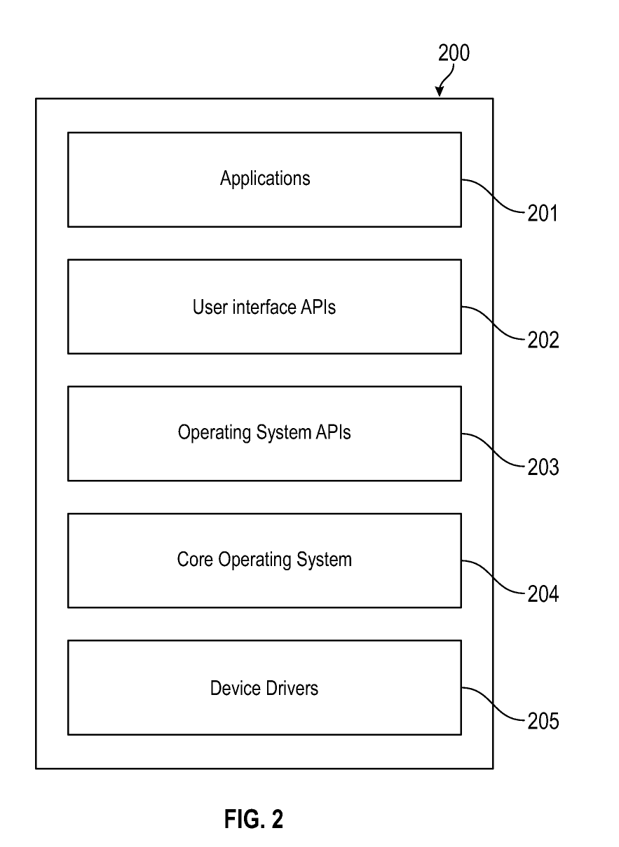

Referring to FIG. 2, the various layers of the architecture 200 of the device 100 will be described.

Software applications 201 are provided at a top layer. Below this layer are user interface APIs 202 which provide access for the application software 201 to user interface libraries. Below this layer are operating system APIs 203 which provide access for the application software 201 and user interface libraries to the core operating system 204. Below the core operating system 204 are the device drivers 205 which provide access to the input 103, output 104, and communication 105 apparatuses.

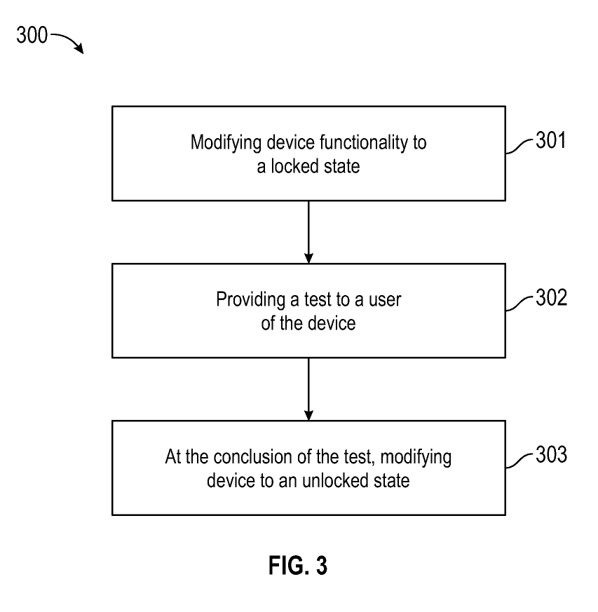

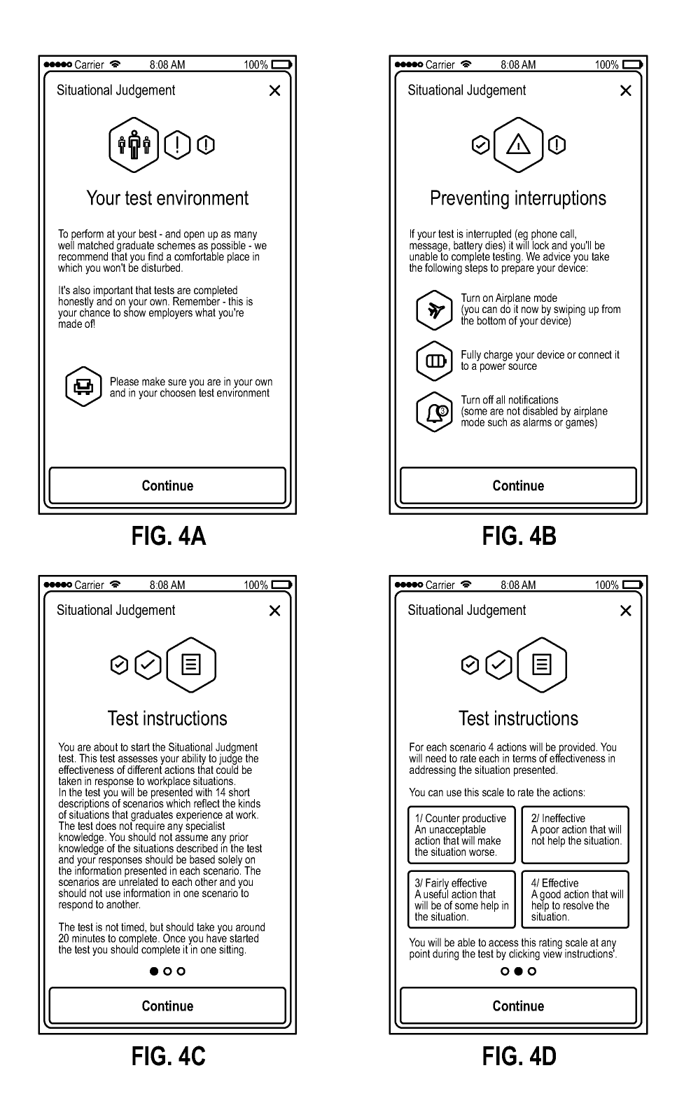

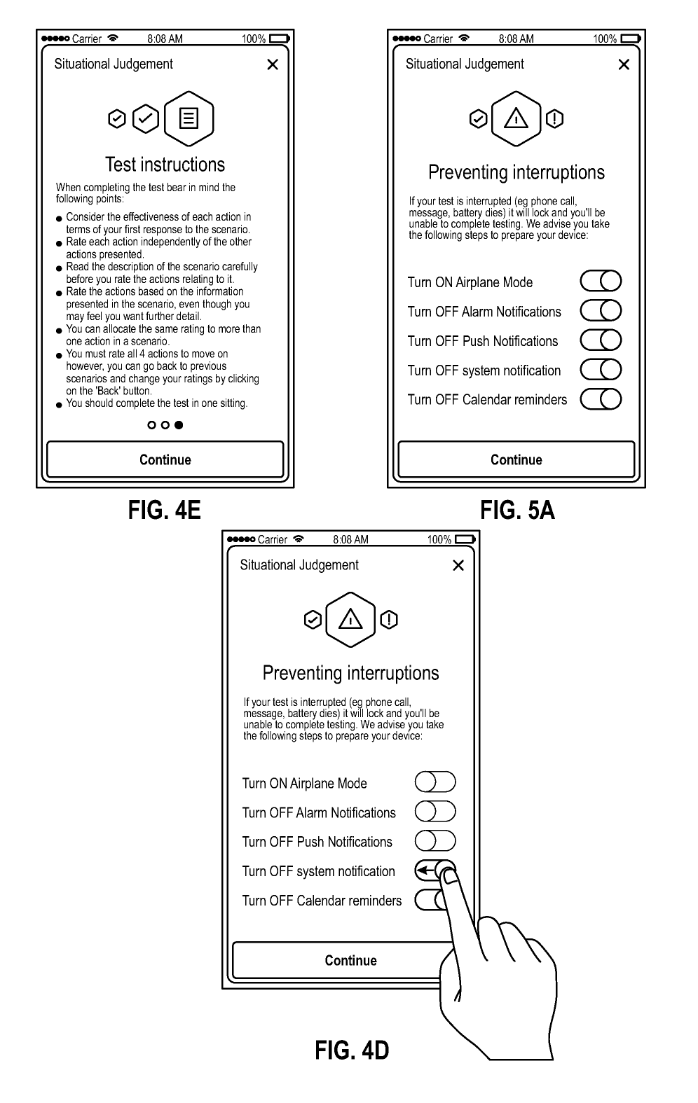

With reference to FIG. 3, a method 300 in accordance with an embodiment of the invention will be described.

In step 301, mobile device functionality is modified to a locked state prior to a testing phase. As discussed above, the mobile device functionality may include one or more of a variety of functions on the device including communications capabilities and access control. For example, device functionality may include one or more of airplane mode, orientation lock, do not disturb, disable alarm, and turn off notifications.

Exemplary code for modifying device functionality on an Android device is provided below:
import android.app.Activity;
import android.content.Intent;
import android.os.Bundle;
import android.provider.Settings;
import android.view.View;
import android.widget.Toast;
public class MainActivity extends Activity {
   @Override
   public void onCreate(Bundle savedInstanceState) {
      super.onCreate(savedInstanceState);
      setContentView(R.layout.activity_main);
   }
   @SuppressWarnings(“deprecation”)
   public void airPlanemodeON(View v) {
      boolean isEnabled=
Settings.System.getInt(this.getContentResolver( )
   Settings.System.AIRPLANE_MODE_ON, 0)==1;
   if (isEnabled==false) {
      modifyAirplanemode(true);
      Toast.makeText(getApplicationContext( )
“Airplane Mode ON”,
   Toast.LENGTH _LONG).show( )
   }
}
public void airPlanemodeOFF(View v) {
   boolean isEnabled=
Settings.System.getlnt(this.getContentResolver( )
   Settings.System.AIRPLANEMODE_ON, 0)==1;
   if (isEnabled==true)// means this is the request to turn ON AIRPLANE mode
   {
      modifyAirplanemode(false);
      Toast.makeText(getApplicationContext( ) “Airplane Mode OFF”,
         Toast.LENGTH _LONG).show( )
   }
}
public void modifyAirplanemode(boolean mode) {
   Settings.System.putInt(getContentResolver( )
      Settings.System.AIRPLANEMODE_ON,
mode ? 1:0);// Turning ON/OFF Airplane mode.
   Intent intent=new
Intent(Intent.ACTION AIRPLANE MODE CHANGED);// creating intent and Specifying action for AIRPLANE mode.
   intent.putExtra(“state”, !mode);// indicate the “state” of airplane mode is changed to ON/OFF
   sendBroadcast(intent);// Broadcasting and Intent
   }
}

In one embodiment, permission is requested from the user before one or more mobile device functionalities are modified into a locked state. Permission may be requested from the user for each of these functionalities or once to modify them all.

In one embodiment, instructions are provided to the user to place the one or more mobile device functionalities into a locked state. For example, the user may be instructed to open settings within the operating system user interface and switch airplane mode on. Before progressing to providing the test, the device may check to determine if the mobile device functionalities have been placed into a locked state.

In step 302, a test is provided to a user of the mobile device within the testing phase. The test may be a psychometric test. The test may be loaded from memory 102, and the answers may be saved in memory 102. In one embodiment, the test and/or answers may be retrieved/transmitted respectively to a server.

In one embodiment, the state of device functionality (e.g. what functionality has been placed into a locked state or not) may be associated with the test undertaken by the user. The state may be saved in the memory 102 and/or transmitted to a server.

In step 303, mobile device functionality is modified to an unlocked state at the conclusion of the testing phase.

FIGS. 4a to 4e show exemplary screenshots illustrating execution of a software application in accordance with an embodiment of the invention.

In this embodiment, various instructions are displayed to a user prior to the testing phase. The instructions include information relating to the user's environment (FIG. 4a), and information about interacting with the test questions (FIG. 4c to FIG. 4e). One screenshot (FIG. 4b) illustrates the display of instructions for the user to follow so that the device functionality can be modified to place the device into a locked state.

FIGS. 5a and 5b show a user interacting with screens generated by a software application executing in accordance with an embodiment of the invention.

In this embodiment, prior to the testing phase, a series of slider user interface elements are displayed for each of a plurality of device functionalities. When the user swipes the slider from on to off, the corresponding device functionality is modified such that the device is placed into a locked state.

A potential advantage of some embodiments of the present invention is that an improved mobile device is provided which enables users to take tests on that device under controlled conditions without the intervention of a human supervisor.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of applicant's general inventive concept.

1. A method for controlling a test environment on a mobile device including:
Modifying device functionality to a locked state prior to a testing phase;
Providing a test to the user within the testing phase; and
Modifying device functionality to an unlocked state at the conclusion of the testing phase.

2. A method as claimed in claim 1, wherein the device functionality includes one or more functions selected from the set of communication capability of the device and access control.

3. A method as claimed in claim 3, wherein communication capability include one or more capabilities selected from the set of phone-calls, text messages, and wifi.

4. A method as claimed in claim 1, wherein the test environment is under control of a software application executing on the device.

5. A method as claimed in claim 4, wherein at least some of the device functionality is modified by the software application.

6. A method as claimed in claim 5, further including the step of receiving confirmation at the software application from the user of the device before the software application modifies the device functionality.

7. A method as claimed in claim 6, wherein confirmation is received for each of the functions modified by the software application.

8. A method as claimed in claim 1, wherein modifying device functionality includes:
providing instructions to the user to modify device functionality; and
receiving input from the user in accordance with the instructions at the operating system of the device to modify the device functionality.

9. A method as claimed in claim 8, wherein a software application executing on the device detects whether the device functionality has been modified by the user.

10. A method as claimed in claim 9, wherein the software application records whether device functionality has been modified with the test.

11. A method as claimed in claim 1, wherein the test is a psychometric test.

12. A method as claimed in claim 1, further including the steps of recording the state of the device functionality and associating the recorded state with the test.

13. A system for controlling a test environment on a mobile device, including:
A processor configured to modify device functionality to a locked state prior to a testing phase, to provide a test to the user within the testing phase and to modify device functionality to an unlocked state at the conclusion of the testing phase; and
A memory configured to store the test.

14. (canceled)

15. A computer readable medium configured to store a computer program which when executed on a mobile device modifies the device functionality to a locked state prior to a testing phase; provides a test to the user within the testing phase; and modifies the device functionality to an unlocked state at the conclusion of the testing phase.

16. (canceled)
